(19) United States
(12) Patent Application Publication
(10) Pub. No.: US 2005/0061875 A1
(43) Pub. Date: Mar. 24, 2005

(54) Method and apparatus for a secure RFID system

(76) Inventors: Li-Cheng Richard Zai, Los Gatos, CA (US); Xinyu Zang, Sunnyvale, CA (US)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/937,580

(22) Filed: Sep. 9, 2004

Related U.S. Application Data
(60) Provisional application No. 60/502,169, filed on Sep. 10, 2003.

(51) Int. Cl. G06K 15/00

(52) U.S. Cl. 235/383

(57) ABSTRACT

The method and apparatus for a secure RFID system provide a secure environment that the passwords are not known by a large number of operators and a reader ceases to operate if it is taken away from its authorized operator. The secure RFID system consists of tags, readers, authentication cards, and digital signature cards. The passwords are stored in the authentication cards and cannot be read by typical operators. The reader ceases to operate if the ticket in the authentication card expires or it is separated from the paired wireless authentication card. The authenticity of the tag data is ensured by using the signature card.

### CROSS REFERENCE TO RELATED APPLICATION

This application claims the benefit of U.S. Provisional Patent Application No. 60/502,169 filed Sep. 10, 2003, the entirety of which is hereby incorporated by reference into this application.

### 1. FIELD OF THE INVENTION

This invention relates generally to RFID (Radio Frequency Identification) systems and more specifically relates to a method and apparatus for a secure RFID system.

### 2. DESCRIPTION OF RELATED ART

RFID tags and readers have recently begun to enter the mass market. FIG. 1 illustrates a typical prior art system 10, in which RFID reader 14 can read and write data to multiple RFID tags 11, 12, and 13. Typically, a user needs to enter passwords into the reader to read/write data into the tags.

A shortcoming of this prior art system is that the use of passwords for accessing the tag memory cannot guarantee security since the passwords are shared by a large number of operators in an open environment, and thus there is the opportunity that the passwords can easily leak to ill-intentioned people. Another shortcoming of this prior art system is that after the RFID reader is enabled by passwords, it can be stolen and used for unauthorized operations.

While the typical prior art systems may be suitable for early deployment of RFID applications, it is desirable to provide an improved system for security purposes in which only authorized sources can read/write RFID tag data.

### SUMMARY OF THE INVENTION

In view of the foregoing disadvantages inherent in RFID systems, the present invention provides a method and apparatus for a secure RFID system. The method and apparatus for a secure RFID system substantially departs from the concept and design of the prior art, and in so doing provides a secure environment in which passwords are not known by a large number of operators and a RFID reader ceases to operate if it is taken away from its authorized operator.

The present invention provides a secure environment in which passwords are not known to typical operators. In the present invention, a RFID reader ceases to operate if an associated authentication card expires or if the RFID reader is separated from a paired wireless authentication card. Alternatively, RFID tag data integrity is ensured by a digital signature.

The present invention generally comprises a RFID system including an RFID reader, RFID tags, and authentication means. For example, the authentication means can be a contact authentication card, wireless authentication card or digital signature card.

In this respect, before explaining at least one embodiment of the invention in detail, it is to be understood that the invention is not limited in its application to the details of construction and to arrangements of the components set forth in the following description and illustrated in the drawings. The invention is capable of other embodiments and being practiced and carried out in various ways. Also, it is to be understood that the phraseology and terminology employed herein are for the purpose of the description and should not be regarded as limiting.

The present invention provides a secure RFID system that has flexible, multiple security levels by using one or more of a contact authentication card, wireless authentication card, and digital signature card. In one embodiment, the present invention provides storing tag passwords in the authentication card such that the passwords cannot be read by typical operators to allow the passwords to be protected.

The present invention also provides for a method that the RFID reader ceases to operate if a security ticket in the authentication card expires.

The present invention also provides for a method that the RFID reader ceases to operate if it is separated from an associated wireless authentication card.

The present invention also provides for a method to ensure a tag data integrity by using signature cards to digitally sign the tag data.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic diagram of a prior art RFID system.

FIG. 2 is a schematic diagram of a secure RFID system in accordance with the teachings of the present invention.

FIG. 3 is a schematic diagram of an embodiment of a RFID reader of the present invention.

FIG. 4 is a schematic diagram of an embodiment of an authentication card or a signature card of the present invention.

FIG. 5 is a schematic diagram of an embodiment of a wireless authentication card of the present invention.

FIG. 6 is a schematic diagram of an embodiment of an IC for the authentication or signature card.

FIG. 7 is a state diagram of the RFID reader, RFID tag and authentication card.

FIG. 8 is a flow chart of a card detection task in a RFID reader's IDLE state.

FIG. 9 is a flow chart of an authentication task in a RFID reader's AUTHENTICATION state.

FIG. 10 is a flow chart of a card verification task in a RFID reader's OPERATION state.

FIG. 11 is a flow chart of a tag authentication task in a RFID reader's OPERATION state.

FIG. 12 is a flow chart of a wait task in the wireless authentication card's IDLE state.

FIG. 13 is a flow chart of the authentication task in the wireless authentication card's AUTHENTICATION state.

FIG. 14 is a flow chart of a connection verification task in a wireless authentication card's OPERATION state.

FIG. 15 is a flow chart of a connection verification state in a contact authentication card's OPERATION state.

FIG. 16 is a ladder diagram of operations among the RFID reader, RFID tag, and contact authentication card.

FIG. 17 is a ladder diagram of operations among the RFID reader, RFID tag, and wireless authentication card.

FIG. 18 is a ladder diagram of operations among the RFID reader, RFID tag, signature card, and wireless authentication card.

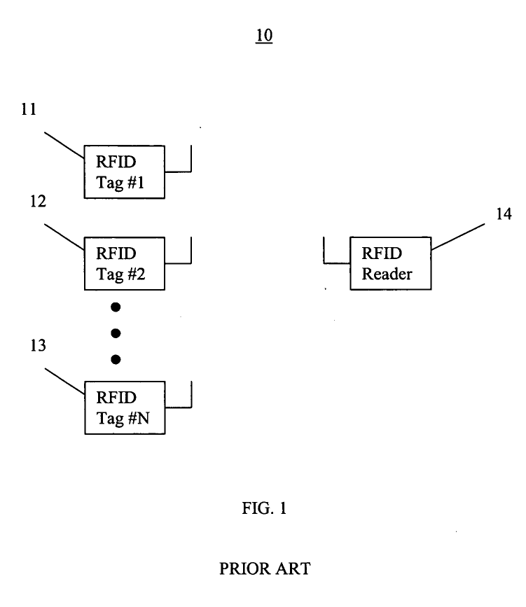

### DESCRIPTION OF THE PREFERRED EMBODIMENT

Reference will now be made in greater detail to a preferred embodiment of the invention, an example of which is illustrated in the accompanying drawings. Wherever possible, the same reference numerals will be used throughout the drawings and the description to refer to the same or like parts.

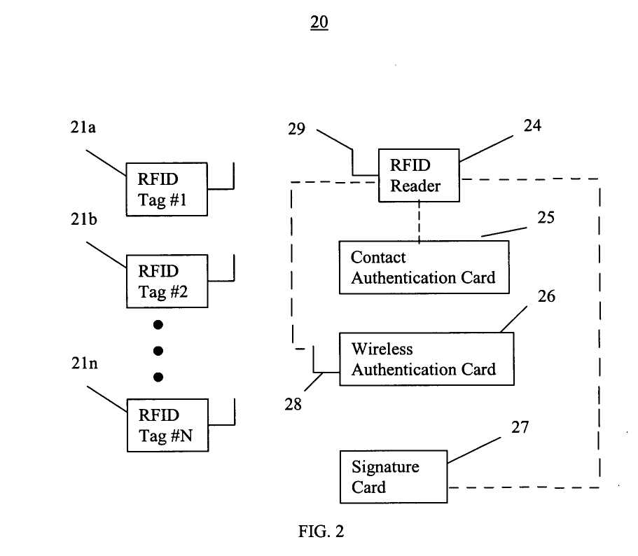

FIG. 2 is a schematic diagram of secure RFID system 20 in accordance with the teachings of the present invention. Secure RFID system 20 comprises RFID tags 21a-21n and RFID reader 24. One or more of contact authentication card 25, wireless authentication card 26, and digital signature card 27 are used in secure RFID system 20.

In an alternate embodiment, contact authentication card 25 enables operation of RFID reader 24 if a security means within contact authentication card 25 is positively paired to a security interface within RFID reader 24.

In a second embodiment, wireless authentication card 26 enables operation of RFID reader 24 if a connection is established between antenna 28 of wireless authentication card 26 and antenna 29 of RFID reader 24 and if a security means within wireless authentication card 26 is positively paired to a security interface within RFID reader 24.

In an alternate embodiment, digital signature card 27 enables operation of RFID reader 24 to write and verify tag data with a digital signature. The digital signature card 27 can be used with wireless authentication card 26 simultaneously or can be combined into contact authentication card 25.

According to different security requirements, there are three typical configurations: (1) RFID reader 24 is used with contact authentication card 25 for low security applications, (2) RFID reader 24 is used with wireless authentication card 26 for medium security applications, and (3) RFID reader 24 is used with wireless authentication card 26 and digital signature card 27 for high security applications.

If RFID reader 24 and contact authentication card 25 are stolen, it will be appreciated that the RFID operation can be compromised before the security means within contact authentication card 25 expires. Compared to the security of using contact authentication card 25, additional safety is provided by using wireless authentication card 26 in that RFID reader 24 immediately ceases operation if wireless authentication card 26 is not detected within its vicinity. Digital signature card 27 generates a digital signature that allows integrity of the RFID tag data to be verified. A digital signature of the tag data is created by hashing the data into a message digest and then encrypting the message digest with a private key stored in digital signature card 27.

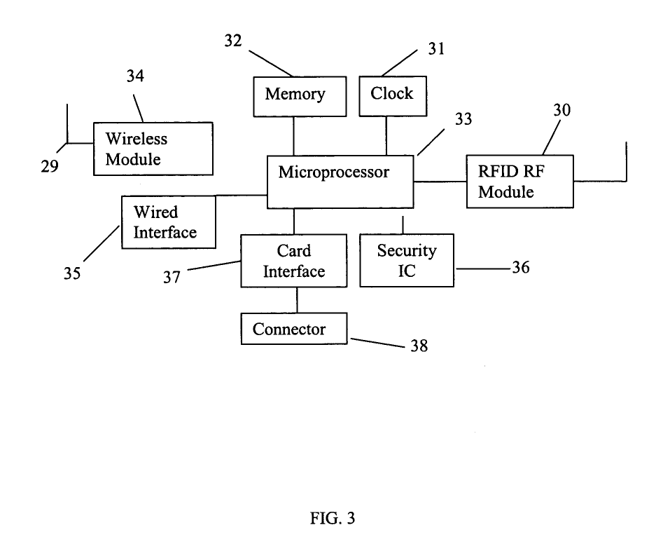

FIG. 3 is a hardware block diagram of RFID reader 24 including RFID module 30, microprocessor 33, one or more memory devices 32 and clock circuit 31. Wireless module 34 and wired interface 35 can be used for network communication to RFID reader 24. Security IC 36, card interface 37, and connector 38 can be used for communicating with contact authentication card 25 and digital signature card 27 and providing security information. Wireless module 34 can be used to communicate with wireless authentication card 26. For some applications, RFID module 30 and wireless module 34 can be combined into one module.

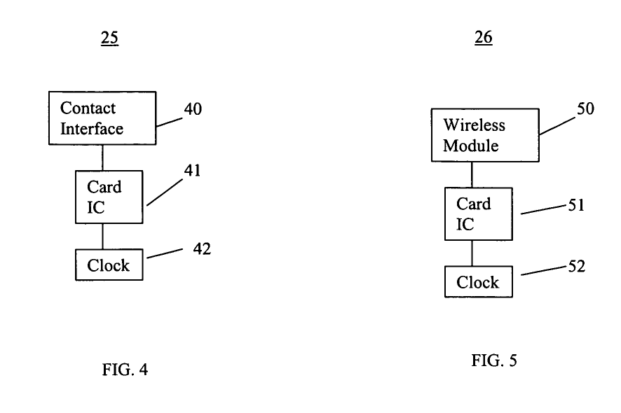

FIG. 4 is a hardware block diagram of an embodiment of contact authentication card 25 comprising contact interface 40, card IC 41 and clock circuit 42. Contact interface 40 can be used to plug into RFID reader 24.

FIG. 5 is a hardware block diagram of wireless authentication card 26 comprising wireless card module 50, card IC 51 and clock circuit 52. Wireless card module 50 can be used to communicate with the RFID reader 24.

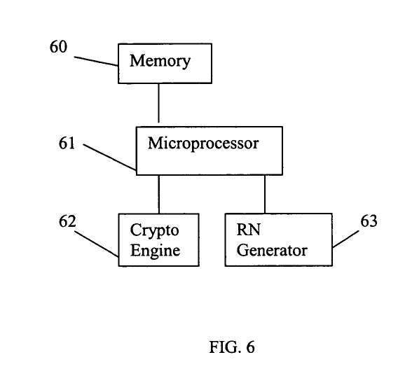

FIG. 6 is a hardware block diagram of an embodiment of card IC 41 for contact authentication card 25. Card IC 41 includes microprocessor 61, memory 60, crypto engine 62, and random number (RN) generator 63. Cypto engine 62 is a hardware circuit that allows fast execution of secret or public key algorithms, and RN generator 63 creates the pseudorandom numbers used in crypto engine 62. A similar configuration can be used for card IC 51 of digital signature card 27.

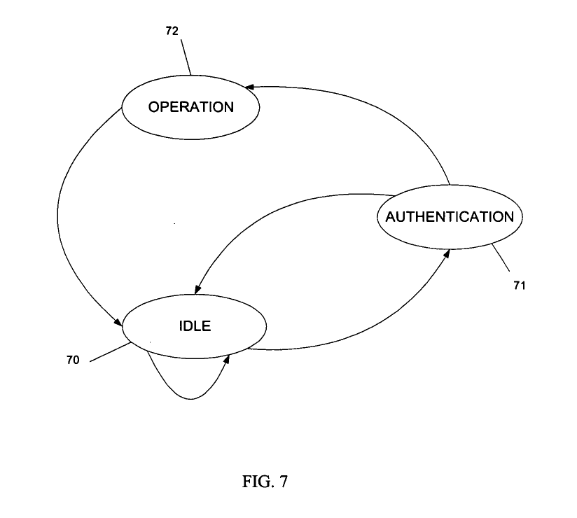

FIG. 7 is a state diagram of secure RFID system 20, for an embodiment of RFID reader 24, RFID tag 21, and one or more of contact authentication card 25, wireless authentication card 26 and digital signature card 27. Each of the devices typically has three operating states: IDLE, AUTHENTICATION, and OPERATION. A device stays in IDLE state 70 until an external event occurs and then moves to AUTHENTICATION state 71. A device advances to OPERATION state 72 if the authentication process is successful. Alternatively, a device returns to IDLE state 70 if the authentication process fails. Data communication between devices occurs in OPERATION state 72. A device goes to IDLE state 70 if the normal communication is completed or an abnormal condition occurs, such a loss of a radio link, failure to detect an authentication card, or a security ticket within the authentication card expires. One or more tasks can be running in each state.

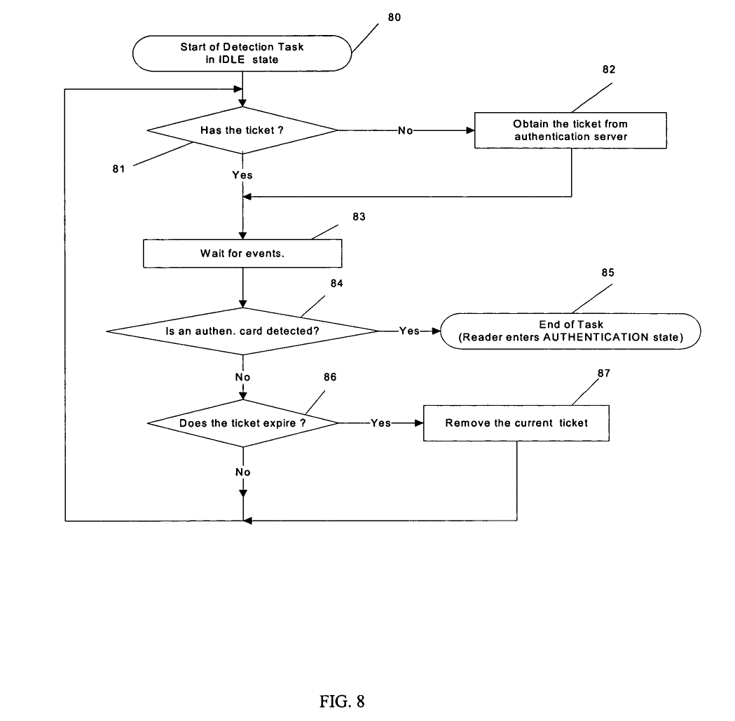

FIG. 8 is a flow chart of a card detection task in IDLE state 70 of RFID reader 24. The task starts from Step 80, and checks the availability of a security ticket in RFID reader 24 in Step 81. If the ticket is not available, the task gets a new ticket in Step 82 from an external authentication server using RFID reader's network interface. Otherwise, the task waits for external events in Step 83. If the event of detecting an external authentication card occurs in Step 84, the task is completed, and the reader moves to AUTHENTICATION state 71 in step 85; otherwise, the task checks the ticket expiration status in Step 86. If the ticket has expired, the task removes the ticket in Step 87. After Step 86 and Step 87, the task returns to Step 81.

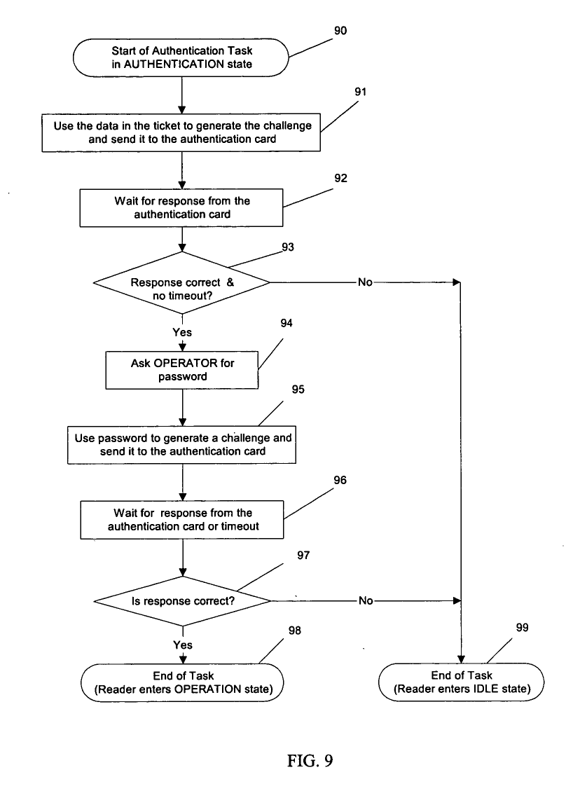

FIG. 9 is a flow chart of an authentication task in RFID reader's AUTHENTICATION state 71. The task starts from Step 90 and uses data in the ticket of RFID reader 24 to generate a challenge to contact authentication card 25 in step 91. The task waits for a response from contact authentication card 25 in Step 92. In Step 93, if the response is correct and there is no timeout event, the task asks the operator for a password in Step 94; otherwise, the task is completed and goes to Step 99. The task uses the password to generate a challenge to contact authentication card 25 in Step 95 and waits for the authentication card's response in Step 96. If the response is correct in Step 97, the task is completed and goes to Step 98 in which RFID reader 24 enters OPERATION state 72; otherwise, the task moves to Step 99 in which RFID reader 24 moves back to IDLE state 70.

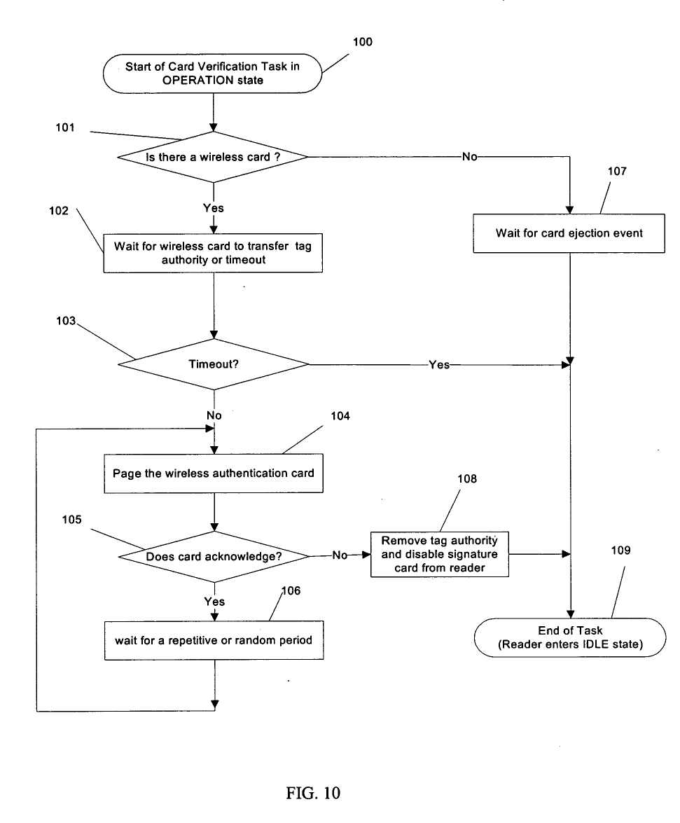

FIG. 10 is a flow chart of a card verification task in the RFID reader's OPERATION state 72. The task starts from Step 100 and checks availability of wireless authentication card 26 in Step 101. If there is no wireless authentication card 26, the task waits for a card ejection event of either contact authentication card 25 or digital signature card 27 in Step 107, and then goes to Step 109. If there is a wireless authentication card 26, the task waits for it to transfer a tag authority to RFID reader 24 in Step 102. If a timeout event occurs, the task forces RFID reader 24 to cease normal operations and to go to IDLE state 70 in Step 109. Otherwise, the task pages wireless authentication card 26 at a repetitive or random time period and waits for the card to acknowledge in Steps 104, 105, and 106. If wireless authentication card 26 fails to acknowledge, the task removes the tag authority transferred from wireless authentication card 26 in Step 102; disables signature card 27 if it is plugged in the RFID reader 24 in Step 108; and forces the RFID reader 24 to go to IDLE state 70 in Step 109.

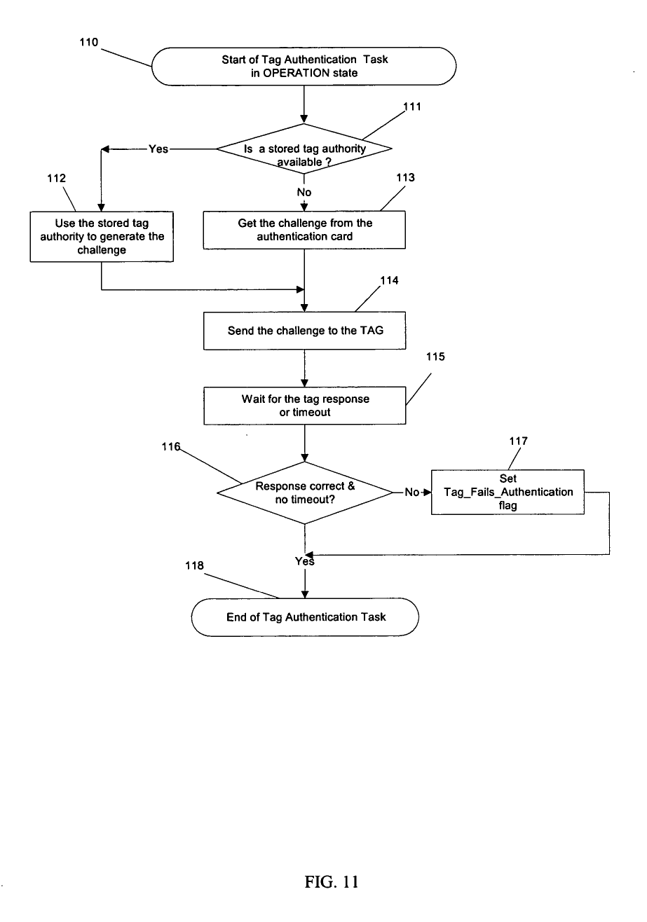

FIG. 11 is a flow chart of a tag authentication task in the RFID reader's OPERATION state 72. The task starts from Step 110 and checks availability of a stored tag authority in Step 111. If there is a stored tag authority when a wireless authentication card 26 is present, the task uses it to generate a challenge by using the security IC 36 of the RFID reader 24 in Step 112; otherwise, the task gets a challenge generated by the card IC 41 from contact authentication card 25 in Step 113. The task sends the challenge to the tag in Step 114 and waits for the tag to respond in Step 115. If the tag response is correct and there is no timeout event in Step 116, the authentication task is completed in Step 118; otherwise a Tag_Fails_Authentication flag is set in Step 117.

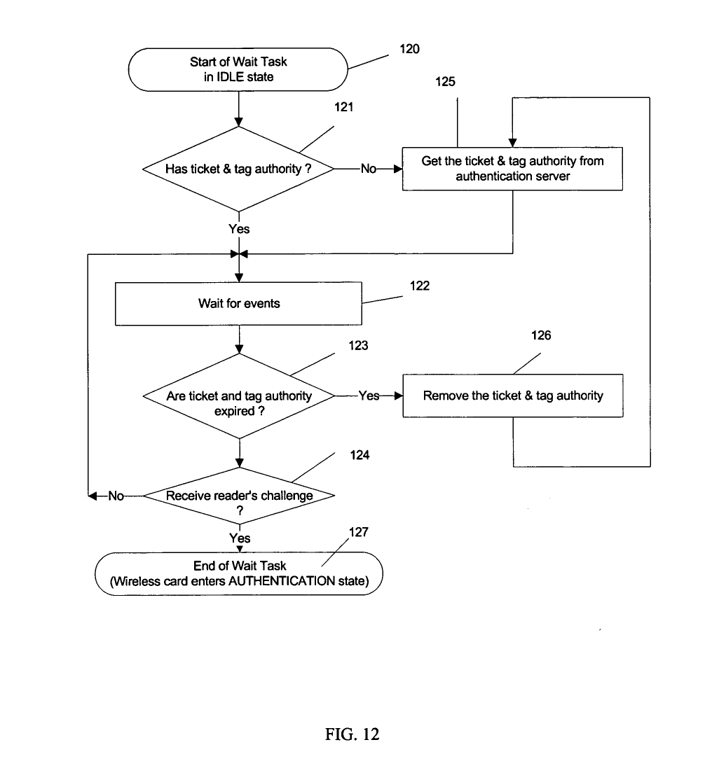

FIG. 12 is a flow chart of a wait task in the IDLE state 70 of wireless authentication card 26. The task starts from Step 120 and checks the availability of the security ticket and tag authority in Step 121. If there is no security ticket and tag authority in the card, the task gets them from an authentication server in Step 125. Otherwise, the task waits for events to happen in Step 122. Once an event occurs, the task first checks expiration status of the ticket and tag authority in Step 123 before it verifies the reception of a RFID reader's challenge in Step 124. If either the security ticket or the tag authority is expired, the task removes them from the card in Step 126 and gets a new one in Step 125. The task is completed and moves to Step 127 if a reader's challenge is received in Step 124.

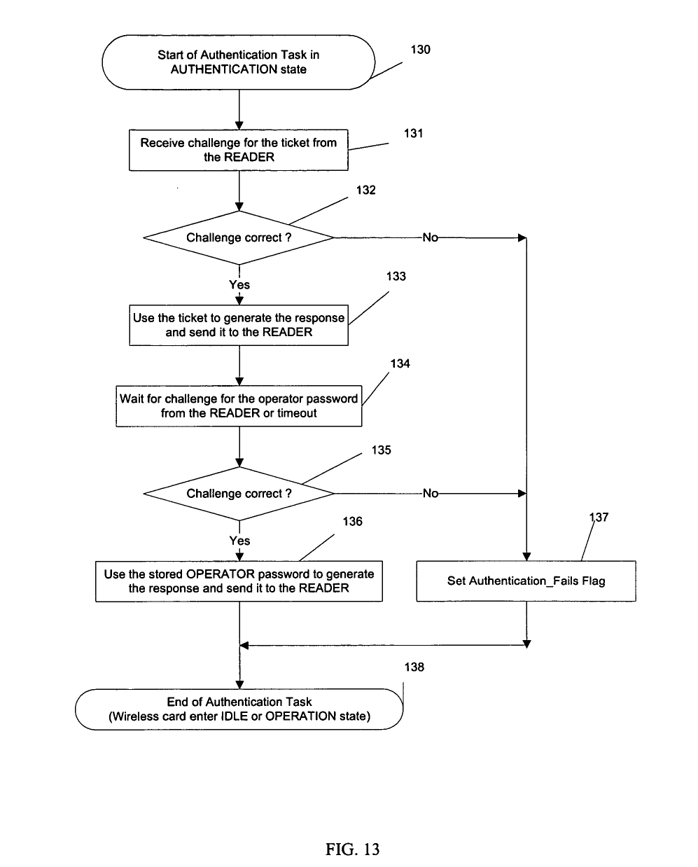

FIG. 13 is a flow chart of an authentication task in the AUTHENTICATION state 72 of wireless authentication card 26. The task starts from Step 130 and receives a challenge for a ticket from RFID reader 24 in Step 131. If the challenge is correct, the task uses the ticket to generate a response and sends it to RFID reader 24 in Step 133. It then waits for a challenge for the operator password from RFID reader 24 in Step 134. If the challenge is correct and there is no timeout event, the tasks uses the stored operator password to generate the response; sends it to RFID reader 24 in Step 136; and ends the task in Step 138. If the condition fails in either Step 132 or 135, the task sets the Authentication_Fails flag in Step 137 and then ends in Step 138.

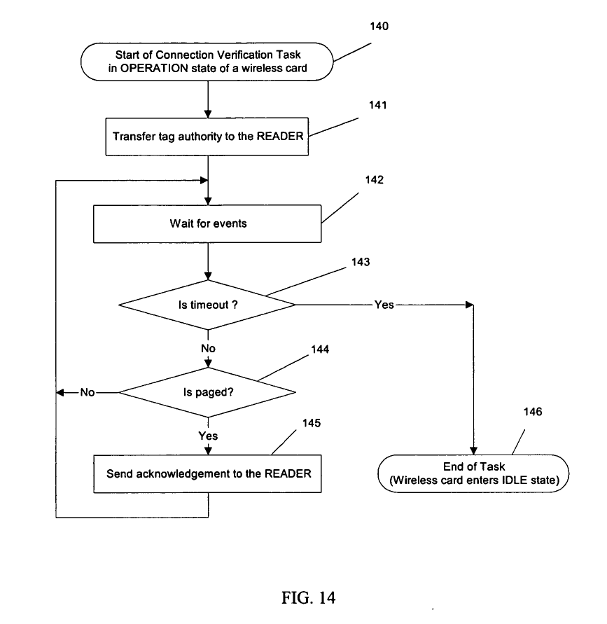

FIG. 14 is a flow chart of a connection verification task in OPERATION state 72 of wireless authentication card 26. The task starts from Step 140; transfers a tag authority to RFID reader 24 in Step 141; and waits for a page event from the reader in Step 142. If a timeout event occurs, the task forces wireless authentication card to IDLE state 70 in Step 146. Otherwise, the task sends acknowledgement to RFID reader 24 in Step 145 and then waits for the next event in Step 142. If wireless authentication card is not paged in Step 144, the task goes to Step 142 to wait for the next event in Step 142.

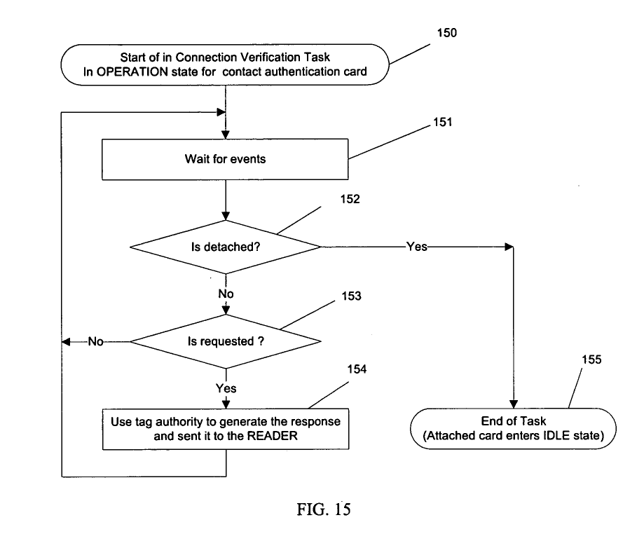

FIG. 15 is a flow chart of a connection verification task in OPERATION state of contact authentication card 25. The task starts from Step 150 and waits for events in Step 151. If a detached event occurred in Step 152, the task forces contact authentication card 25 to IDLE state 70 in Step 155. Otherwise, the task uses a tag authority to generate a response and sends it to the RFID reader 24 in Step 154 after a request event is confirmed in Step 153. If there is no request event in Step 153, the task goes to Step 151 to wait for the next event.

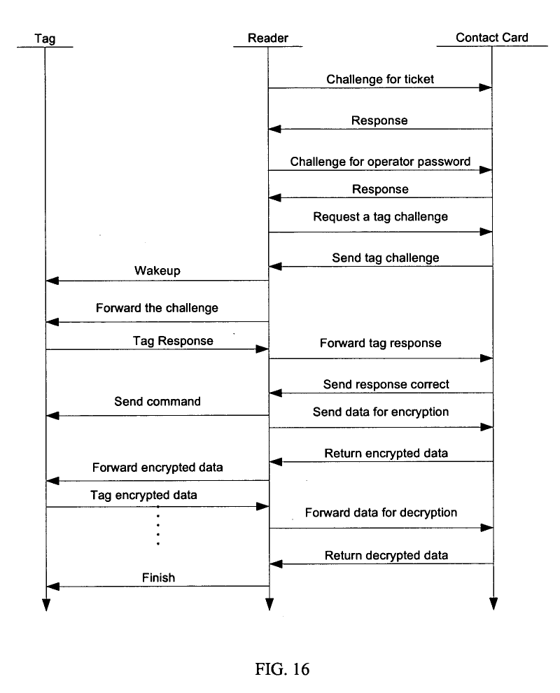

FIG. 16 shows a ladder diagram of operations among RFID reader 24, contact authentication card 25, and RFID tag 21. For the mutual authentication among the RFID reader 24, contact authentication card 25, and the operator, RFID reader 24 sends challenges to contact authentication card 25 for a ticket and operator password and then verifies the responses. Before the tag authentication process, RFID reader 24 requests and obtains a challenge to the tag from the card. After these steps and in the tag authentication process, RFID reader 24 wakes up RFID tag 21 and sends it a challenge. A tag response from RFID tag 21 is forwarded to contact authentication card 25 for verification. If the response is correct, normal data operations occur between RFID reader 24 and RFID tag 21 until contact authentication card 25 is removed from RFID reader 24 or operations are completed.

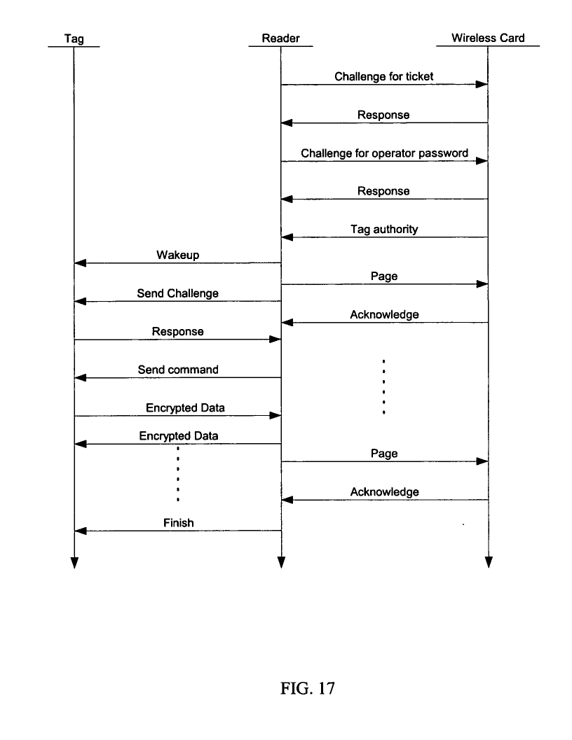

FIG. 17 shows the ladder diagram of operations among RFID reader 24, wireless authentication card 26, and RFID tag 21. For the mutual authentication among the RFID reader 24, wireless authentication card 26, and the operator, RFID reader 24 sends challenges to wireless authentication card 26 for a ticket and operator password, and then verifies the responses. After these steps, wireless authentication card 26 transfers the tag authority to RFID reader 24. In the tag authentication process, RFID reader 24 wakes up RFID tag 21 and sends it a challenge. If the response is correct, normal data operations occur between RFID reader 24 and RFID tag 21 until wireless authentication card 26 fails to respond to page signals sent from RFID reader 24 or operations are completed.

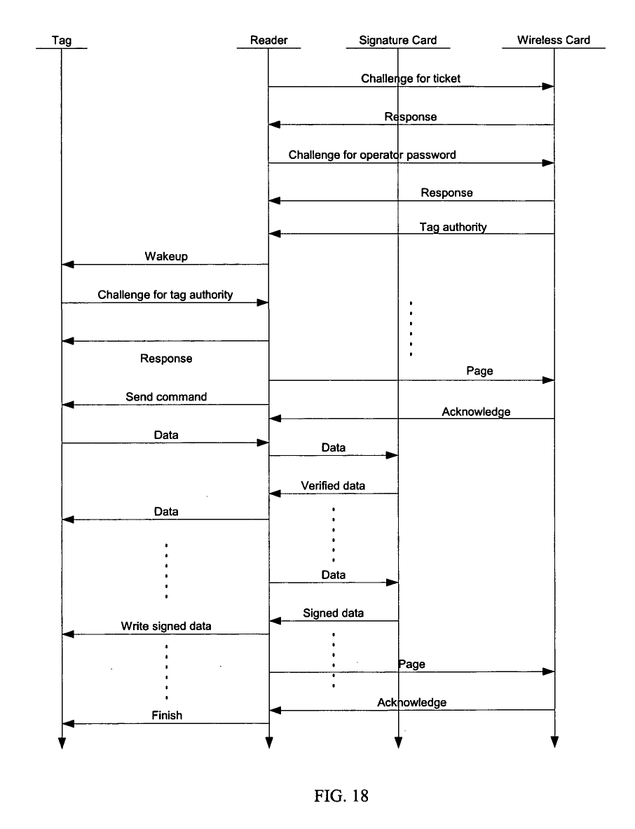

FIG. 18 shows the ladder diagram of operations among RFID reader 24, digital signature card 27, wireless authentication card 26, and RFID tag 21. For the mutual authentication among the RFID reader 24, wireless authentication card 26, and the operator, RFID reader 24 sends challenges to wireless authentication card 26 for a ticket and operator password, and then verifies the responses. After these steps, wireless authentication card 26 transfers the tag authority to RFID reader 24, In the tag authentication process, RFID reader 24 wakes up RFID tag 21 and sends it a challenge. If the response is correct, normal data operations occur between RFID reader 24 and RFID tag 21 until wireless authentication card 26 fails to respond to the page signals sent from RFID reader 24 or operations are completed. If there is any data needed to be verified or signed, RFID reader 24 sends this data to digital signature card 27 for these operations.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

1. A secure RFID system comprising:
one or more RFID tags;
a RFID reader communicating with said one or more RFID tags; and
authentication means for providing different levels of security for said RFID reader.

2. The secure RFID system of claim 1 wherein said authentication means comprises one or more of a contact authentication card, wireless authentication card, or digital signature card.

3. The secure RFID system of claim 2 wherein said authentication means is said contact authentication card, said contact authentication card enabling operation of said RFID reader if a security means within said contact authentication card is positively paired to a security interface within said RFID reader.

4. The secure RFID system of claim 3 wherein said security means comprises:
one or more security tickets, one or more operator passwords, and one or more of the tag authorities, said one or more security tickets, said one or more operator passwords and said one or more tag authorities being directly received from an authentication server; and
means for storing said one or more security tickets, said one or more operator passwords and said one or more tag authorities in said contact authentication card; and
means for storing said one or more security tickets in said RFID reader.

5. The secure RFID of claim 4 wherein said authentication means uses said security ticket of said contact authentication card to generate a challenge to said contact authentication card.

6. The secure RFID system of claim 5 wherein said authentication means verifies a response of said authentication card to said challenge and upon verification of said contact authentication card, data operations occur between said RFID reader and said contact authentication card.

7. The secure RFID system of claim 4 wherein said authentication means uses said one or more operator passwords to generate a challenge to said authentication card.

8. The secure RFID system of claim 7 wherein said authentication means verifies a response of said authentication card to said challenge and upon verification of said contact authentication card, data operations occur between said RFID reader and an operator of said RFID system.

9. The secure RFID system of claim 4 wherein said authentication means uses said one or more tag authorities to generate a challenge to said one or more RFID tags.

10. The secure RFID system of claim 9 wherein said authentication means verifies a response of said one or more RFID tags to said challenge and upon verification of said one or more RFID tags, data operations occur between said RFID reader and said one or more RFID tags.

11. The secure RFID system of claim 10 wherein said authentication means provides encrypting and decrypting of data to be sent between said RFID reader and said one or more RFID tags during said data operations.

12. The secure RFID system of claim 4 wherein said authentication means further comprises connection means for establishing a physical connection between said contact authentication card and said RFID reader, and said authentication means forces said RFID reader to become idle if said physical connection is removed between said contact authentication card and said RFID reader.

13. The secure RFID system of claim 4 wherein:
said contact authentication card sends a signal to said RFID reader that becomes idle when said security ticket, or one or more tag authorities expires.

14. The secure RFID system of claim 2 wherein said authentication means is said wireless authentication card, said wireless authentication card enabling operation of said RFID reader if a security means within said wireless authentication card is positively paired to a security interface within said RFID reader.

15. The secure RFID system of claim 14 wherein said security means comprises:
one or more security tickets, one or more operator passwords and one or more of the tag authorities, said one or more security tickets, one or more operator passwords and said one or more tag authorities being directly received from an authentication server; and
means for storing said one or more security tickets, one or more operator passwords and said one or more tag authorities in said wireless authentication card, and
means for storing said one or more security tickets in said RFID reader.

16. The secure RFID system of claim 15 wherein said authentication means uses said security ticket in said wireless authentication card to generate a challenge to said wireless authentication card.

17. The secure RFID system of claim 16 wherein said authentication means verifies a response of said wireless authentication card to said challenge and upon verification of said wireless authentication card, data operations occur between said RFID reader and said wireless authentication card.

18. The secure RFID system of claim 15 wherein said authentication means uses said one or more operator passwords to generate a challenge to said wireless authentication card.

19. The secure RFID system of claim 18 wherein said authentication means verifies a response of said wireless authentication card upon verification of said wireless authentication card, data operations occur between said RFID reader and said operator of said RFID system.

20. The secure RFID system of claim 15 wherein said authentication means said tag authority in said wireless authentication card is transferred to said RFID reader.

21. The secure RFID system of claim 15 wherein said authentication means uses said one or more tag authorities to generate a challenge to said one or more RFID tags.

22. The secure RFID system of claim 21 wherein said authentication means verifies a response of said one or more RFID tags to said challenge and upon verification of said one or more RFID tags, data operations occur between said RFID reader and said one or more RFID tags.

23. The secure RFID system of claim 14 wherein said authentication means forces said RFID reader to become idle if said wireless authentication card fails to respond to one or more signals sent by said RFID reader.

24. The secure RFID system of claim 15 wherein said wireless authentication card sends a signal to said RFID reader to become idle when said security ticket, or said one or more tag authorities expires.

25. The secure RFID system of claim 2 wherein said authentication means is said digital signature card, said digital signature card generating and verifying the data integrity of said one or more RFID tags if a digital signature is enabled using a security interface within said RFID reader.

26. The secure RFID system of claim 2 wherein said authentication means comprises said contact authentication card.

27. The secure RFID system of claim 2 wherein said authentication means comprises said wireless authentication card.

28. The system of claim 2 wherein said authentication means comprises said wireless authentication card and said digital signature card.

29. A method for providing security of a RFID system comprising the steps of:
a. selecting a level of security for said RFID reader;
b. using an authentication means for establishing said level of security;
c. after establishing said level of security, connecting a RFID reader to one or more RFID tags to provide for an electrical connection or wireless connection between said RFID reader and said one or more RFID tags.

30. The method of claim 29 wherein said authentication means comprises one or more of a contact authentication card, a wireless authentication card or a digital signature card.

31. The method of claim 29 wherein in step b., said RFID reader, said one or more RFID tags and said authentication means are in an IDLE state until an external event occurs and after said external event occurs in step b. further comprises the steps of moving said RFID reader, said one or more RFID tags and said RFID authentication means into an Authentication state.

32. The method of claim 29 wherein step c. further comprises the step of:
moving said RFID reader, said RFID tag and said authentication means to an OPERATION state after establishing said level of security.

33. The method of claim 32 further comprising step of:
checking for expiration of said authentication means, if said authentication means has expired, moving said RFID reader, and said authentication means to said IDLE state.

34. The method of claim 32 wherein if said electrical connection or said wireless connection between said RFID reader and said authentication means fails further comprising the step of moving said RFID reader and said authentication means to said IDLE state.

35. The method of claim 30 wherein said authentication means comprises said contact authentication card and step b. comprises the steps of:
sending a security ticket challenge from said RFID reader to said contact authentication card;
determining if said security ticket challenge is correct; and
if said security ticket challenge is correct, responding to said security ticket challenge by sending a security ticket response from said contact authentication card to said RFID reader.

36. The method of claim 35 further comprising the steps of:
sending an operator password challenge from said RFID reader to said contact authentication card;
determining if said operator password challenge is correct; and
if said operator password challenge is correct, responding to said operator password challenge by sending an operator password response from said contact authentication card to said RFID reader.

37. The method of claim 36 further comprising the steps of:
sending a request for a RFID tag challenge from said RFID reader to said contact authentication card;
sending said RFID tag challenge from said contact authentication card to said RFID reader;
upon receipt of said RFID tag challenge, sending a wake up request to said RFID tag; and
sending said RFID tag challenge to said RFID tag.

38. The method of claim 37 further comprising the steps of:
said RFID tag responding to said RFID tag challenge by sending a RFID tag response to said RFID reader, said RFID reader forwarding said RFID tag response to said contact authentication card; and
verifying said RFID tag response at said contact authentication card.

39. The method of claim 38 further comprising the steps of:
sending data for encryption from said RFID reader to said contact authentication card;
encrypting said data for encryption at said contact authentication card to form encrypted data;
returning said encrypted data from said contact authorization card to said RFID reader; and
sending said encrypted data from said RFID reader to said RFID tag.

40. The method of claim 39 further comprising the steps of:
sending data for decryption from said RFID tag to said RFID reader;
forwarding said data for decryption from said RFID reader to said contact authentication card; and
decrypting said data for decryption at said contact authentication card to form decrypted data; and
returning said decrypted data from said contact authentication card to said RFID reader.

41. The method of claim 30 wherein said authentication means comprises said wireless authentication card and step b. comprises the steps of:
sending a security ticket challenge from said RFID reader to said wireless authentication card;
determining if said security ticket challenge is correct; and
responding to said security ticket challenge by sending a security ticket response from said wireless authentication card to said RFID reader.

42. The method of claim 41 further comprising the steps of:
sending an operator password challenge from said RFID reader to said wireless authentication card;
determining if said operator password challenge is correct; and
if said operator password challenge is correct, responding to said operator password challenge by sending an operator password response from said wireless authentication card to said RFID reader.

43. The method of claim 42 further comprising the steps of:
sending said tag authority from said wireless authentication card to said RFID reader;
using said tag authority to generate the a RFID tag challenge at said RFID reader;
sending a wake up request to said RFID tag; and
sending said RFID tag challenge to said RFID tag.

44. The method of claim 43 further comprising the steps of:
responding to said RFID tag challenge by sending a RFID tag response to said RFID reader; and
verifying said RFID tag response at said RFID reader.

45. The method of claim 44 further comprising the step of:
sending a page at a repetitive or random time period from said RFID reader to said wireless authentication card; and
waiting at said RFID reader for an acknowledgement to be received from said wireless authentication card.

46. The method of claim 45 wherein if said acknowledgement is received;
sending encrypted data from said one or more RFID tags to said RFID reader and/or sending encrypted data from said one or more RFID tags to said RFID reader.

47. The method of claim 46 wherein if said acknowledgement is not received within a predetermined time period further comprising the step of:
removing said tag authority from said RFID reader.

48. The method of claim 30 wherein said authentication means comprises said wireless authentication card, and said digital signature card and step b. comprises the steps of:
sending a security ticket challenge from said RFID reader to said wireless authentication card;
determining if said security ticket challenge is correct; and
responding to said challenge by sending a security ticket response from said wireless authentication card to said RFID reader.

49. The method of claim 48 further comprising the steps of:
sending an operator password challenge from said RFID reader to said wireless authentication card;
determining if said operator password challenge is correct;
if said operation password challenge is correct, responding to said operator password challenge by sending an operator password response from said wireless authentication card to said RFID reader.

50. The method of claim 49 further comprising the steps of:
sending said tag authority from said wireless authentication card to said RFID reader;
using said tag authority to generate a RFID tag challenge at said RFID reader;
sending a wake up request to said RFID tag; and
sending said RFID tag challenge to said RFID tag.

51. The method of claim 50 comprising the steps of:
sending data from said RFID tag to said RFID reader;
forwarding said data received from said RFID reader to said digital signature card for verification; and
said data is verified at said digital signature card and
returning verified data to said RFID reader.

52 The method of claim 51 comprising the steps of:
sending data from said RFID reader to said RFID tag;
forwarding said data generated from said RFID reader to said digital signature card for signature; and
signing said data at said digital signature card to form signed data; and
forwarding said signed data from said RFID reader to said RFID tag.

53. The method of claim 52 further comprising the step of:
sending a page at a repetitive or random time period from said RFID reader to said wireless authentication card; and
waiting at said RFID reader for an acknowledgement to be received from said wireless authentication card.

54. The method of claim 53 wherein if said acknowledgement is not received within a predetermined time period;
further comprising the steps of removing said tag authority from said RFID reader and disabling said digital signature card.
